(19) United States
(12) Patent Application Publication
(10) Pub. No.: US 2011/0222399 A1
(43) Pub. Date: Sep. 15, 2011

(54) QUALITY OF SERVICE MANAGEMENT METHOD, DEVICE AND SYSTEM (Amended)

(75) Inventors: Wencan Shi, Shanghai (CN); Qi Ouyang, Shanghai (CN)

(73) Assignee: CHINA MOBILE GROUP SHANGHAI CO., LTD., Shanghai (CN)

(21) Appl. No.: 13/059,914

(22) PCT Filed: Jun. 23, 2009
(86) PCT No.: PCT/CN2009/000700

§ 371 Date: May 6, 2011

(30) Foreign Application Priority Data
Aug. 19, 2008 (CN) 200810118708.1

(51) Int. Cl. H04W 28/18

(52) U.S. Cl. 370/230

(57) ABSTRACT

A quality of service QoS management method, apparatus and system are disclosed. The method includes: receiving Qos information requested by a core network device, wherein the Qos information is assigned to a current originated session according to a Qos negotiation result during a user equipment UE session origination phase; according to the requested Qos information assigned to the current originated session, Qos information occupied by a current serving session of an access point AP accessed by the UE, and Qos associated information of the AP, determining and recording the Qos information occupied by the current originated session; and the AP establishing a wireless bearer with the UE according to the QoS information occupied by the current originated session.

### FIELD OF INVENTION

The present invention relates to the field of communications and particularly to a quality of service management technology.

### BACKGROUND OF INVENTION

In recent years, services in the field of communications have been greatly enriched and exhibited a development trend of diversification and individuation so that the importance of Quality of Service (QoS) management has been increasingly prominent. For a mobile communication system with limited resources, the QoS management has to accommodate QoS demands of different users and services to achieve differentiated services and also shall prevent excessive resources from being allocated to the users and the services to improve the ratio of utilizing the resources of the system. A Universal Mobile Telecommunication System (UMTS) provides operators with a degree of freedom for QoS management by making it become a strictly qualitatively defined management mechanism. The 3^{rd} Generation Partnership Project (3GPP) Release 4 (R4) has defined a QoS negotiation mechanism of the UMTS, and the 3GPP R5 has defined a QoS policy control mechanism while proposing the IP Multimedia Subsystem (IMS), where both the QoS negotiation mechanism and the QoS policy control mechanism come into the concept of QoS management. The foregoing QoS negotiation mechanism and QoS policy control mechanism defined for the UMTS are proposed for a specific service of a user.

Along with constant emergence of new application scenarios and new services in the mobile communication system, the requirement on differentiated services for users and services has been further extended to differentiated QoS management on Access Points (APs), but the QoS negotiation mechanism and QoS policy control mechanism defined for the UMTS can not be simply applied to accommodate this requirement. Taking a Femtocell/Femto system applied in a home scenario as an example, FIG. 1 illustrates an architecture diagram of a typical Femto system that consists of a User Equipment (UE), a Femto AP (also referred to as a Femto base station), a Femto gateway and a Core Network (CN). The Femto AP is arranged indoors to provide the UE hosted by the Femto AP with an access service via an air interface so that the UE can perform functions of voice communication, accessing the Internet, etc.; an interface between the Femto AP and the Femto gateway is referred to as an Fa interface, the Femto AP and the Femto gateway are typically connected over an Internet Protocol (IP) transmission network; and the CN includes functional entities of a Mobile Switching Center (MSC) in the circuit domain, a Service GPRS Support Node (SGSN) and a Gateway GPRS Support Node (GGSN) in the packet domain, and a Femto Home Location Register (HLR)/Home Subscriber Server (HSS) and an Authentication Authorization and Accounting (AAA) server. The CN may be connected to the Internet through the GGSN. Femto APs with different deployment sites and affiliation from macro base stations (e.g., Base Stations, NodeBs, eNodeBs) thus have both been applied at home and become terminal-like, and the macro base stations are not comparable to the Femto APs in terms of their number, growing speed and randomicity. Differentiated QoS management on Femto APs has become an issue desired to be addressed in the Femto system.

In the prior art, the differentiated QoS management has been implemented on the UEs while the CN acts as a center of the QoS management, and if this solution is extended to the QoS management on Femto APs, the following issue may arise: in the existing Femto system, a Femto AP is provided with a part of functions of a Radio Network Controller (RNC), and Femto APs may be converged through the Femto gateway, which in turn is connected directly with the CN, thereby avoiding an impact to the CN due to a large number of Femto APs accessing the network, therefore, when the UE initiates a session, the CN may not be provided with information on a Femto AP via which the session is initiated and consequently fails to associate and bind the session of the UE with the Femto AP via which the session is initiated; and if the CN is provided with the information on the Femto AP via which the UE initiates the session, there will inevitably be a lot of additional signaling interaction and the CN has to carry on QoS negotiation for a large number of Femto APs, which may incur an immeasurable stress to the CN. Apparently, there is a lack in the prior art of an appropriate solution for differentiated QoS management on Femto APs.

### SUMMARY OF THE INVENTION

Embodiments of the invention provide a quality of service management method, device and system to implement differentiated quality of service management on access points.

An embodiment of the invention provides a quality of service management method including:

receiving information on a quality of service as requested, according to a result of quality of service negotiation, from a core network device when a user equipment initiates a session for allocation to the initiated session;

determining and recording information on a quality of service occupied by the initiated session according to the information on the quality of service as requested for allocation to the initiated session, information on quality of services occupied by sessions currently served by an access point accessed by the user equipment and quality of service related information of the access point; and

setting up, by the access point, a radio bearer to the user equipment according to the information on the quality of service occupied by the initiated session.

An embodiment of the invention provides a quality of service management device including:

a reception unit configured to receive information on a quality of service as requested, according to a result of quality of service negotiation, from a core network device when a user equipment initiates a session for allocation to the initiated session; and

a management unit configured to determine and record information on a quality of service occupied by the initiated session according to the information on the quality of service as requested for allocation to the initiated session, information on quality of services occupied by sessions currently served by an access point accessed by the user equipment and quality of service related information of the access point.

An embodiment of the invention provides a quality of service management system including:

a storage sub-system configured to store quality of service related information of access points;

a core network device configured, when a user equipment initiates a session, to carry on quality of service negotiation for the initiated session, and request information on a quality of service for allocation to the initiated session according to a result of quality of service negotiation; and

a gateway device configured to receive the information on the quality of service as requested from the core network device for allocation to the initiated session, determine and record information on a quality of service occupied by the initiated session according to the information on the quality of service as requested for allocation to the initiated session, information on quality of services occupied by sessions currently served by an access point accessed by the user equipment and the quality of service related information of the access point obtained from the storage sub-system, and instruct the access point to set up a radio bearer to the user equipment according to the information on the quality of service occupied by the initiated session.

In the quality of service management method according to the embodiment of the invention, as a basis of setting up the radio bearer between the access point and the user equipment, the information on the quality of service occupied by the initiated session is determined according to the information on the quality of service as requested for allocation to the initiated session, the information on the quality of services occupied by the sessions currently served by the access point accessed by the user equipment and the quality of service related information of the access point, to perform real time associating and binding of the initiated session with the access point via which the session is initiated, thereby performing real time and effective differentiated quality of service management on the access points.

### BRIEF DESCRIPTION OF THE DRAWINGS

FIG. 1 illustrates an architecture diagram of a typical Femto system in the prior art;

FIG. 2 illustrates a flow chart of a QoS management method according to an embodiment of the invention;

FIG. 3 illustrates a structural diagram of an improved 3GPP R4 Femto system with an Iu protocol based Fa interface according to a first embodiment of the invention;

FIG. 4 illustrates a flow chart of signaling for QoS management on a Femto AP according to the first embodiment of the invention;

FIG. 5 illustrates a flow chart of a process of determining information on a QoS occupied by an initiated session according to the first embodiment of the invention;

FIG. 6 illustrates a structural diagram of an improved 3GPP PCC architecture Femto system with an Iu protocol based Fa interface according to a second embodiment of the invention;

FIG. 7 illustrates a block diagram of a QoS management system according to an embodiment of the invention; and

FIG. 8 illustrates a structural block diagram of a QoS management device according to an embodiment of the invention.

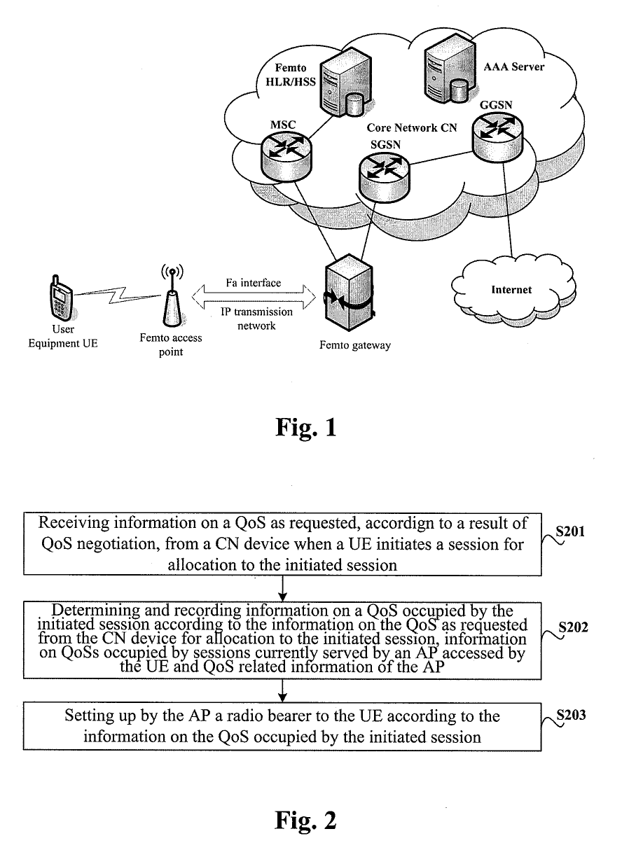

### DETAILED DESCRIPTION OF THE EMBODIMENTS

An embodiment of the invention provides a QoS management method to accommodate required differentiated QoS management on APs, and as illustrated in FIG. 2, the method includes the following processes:

S201. information on a QoS as requested, according to a result of QoS negotiation, from a CN device when a UE initiates a session for allocation to the initiated session is received;

S202. information on a QoS occupied by the initiated session is determined and recorded according to the information on the QoS as requested from the CN device for allocation to the initiated session, information on QoSs occupied by sessions currently served by an AP accessed by the UE and QoS related information of the AP; and

S203. a radio bearer is set up by the AP to the UE according to the information on the QoS occupied by the initiated session.

Preferably, a gateway device may act as a center of QoS negotiation and QoS policy control at the radio access side, that is, processes S201 and S202 are performed by the gateway device hosting the AP. Of course, processes S201 and S202 may alternatively be performed by another network entity, e.g., the AP itself or a network entity capable of radio access control.

The QoS related information of the AP may be QoS subscription information of the AP or QoS authorization information of the AP.

In the QoS management method according to the embodiment of the invention, as a basis of setting up the radio bearer between the AP and the UE, the information on the QoS occupied by the initiated session is determined according to the information on the QoS as requested for allocation to the initiated session, the information on the QoSs occupied by the sessions currently served by the AP accessed by the UE and the QoS related information of the AP, to implement real time associating and binding of the initiated session with the AP via which the session is initiated, thereby performing real time and effective differentiated QoS management on the AP.

The QoS management method in various specific application scenarios will be detailed below with reference to the drawings by way of an example in which a gateway device acts as a center of QoS negotiation and QoS policy control at the radio access side.

### A First Embodiment

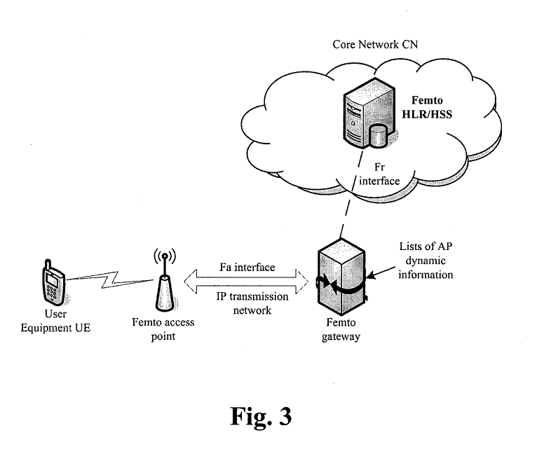

In the present embodiment, a specific application scenario involves a 3GPP R4 Femto system with an Iu protocol based Fa interface. Particularly, the gateway device is a Femto gateway, the AP is a Femto AP hosted by the Femto gateway, the CN device is an MSC server if a session is borne in the circuit domain or an SGSN if the session is borne in the packet domain, and related information of the Femto AP is subscription information of the Femto AP, which refers to a requirement on a QoS for which the Femto AP subscribes with an operator. In the present embodiment, the Femto gateway acts as a center of QoS negotiation and QoS policy control at the radio access side of the Femto system to perform differentiated QoS management on the Femto AP, thereby extending controllable links of QoS management in the Femto system and improving an end-to-end QoS management mechanism. In order to implement the present solution, improvements to an existing 3GPP R4 Femto system with an Iu protocol based Fa interface are introduced with reference to FIG. 3, which include:

an additional subscription information storage entity in which QoS subscription information of Femto APs is stored and which is configured to receive a query about QoS subscription information of a Femto AP from the Femto gateway and return the QoS subscription information of the Femto AP to the Femto gateway in response to the query;

the subscription information storage entity may be implemented by updating a Femto HLR/HSS or an AAA server. Referring to FIG. 3 illustrating an updated Femto HLR/HSS as an example, the QoS subscription information of the Femto APs is stored in the Femto HLR/HSS, and the Femto HLR/HSS is connected with the Femto gateway via an Fr interface, and receives a query about QoS subscription information of a Femto AP from the Femto gateway and returns the QoS subscription information of the Femto AP to the Femto gateway in response to the query, via the Fr interface;

if the subscription information storage entity is implemented by updating the AAA server, the QoS subscription information of the Femto APs is stored in the AAA server; and the AAA server enables a Wm interface for connection with the Femto gateway, and receives a query about QoS subscription information of a Femto AP from the Femto gateway and returns the QoS subscription information of the Femto AP to the Femto gateway in response to the query, via the Wm interface;

correspondingly, the Femto gateway obtains the QoS subscription information of the Femto AP from the Femto HLR/HSS via the Fr interface or is arranged therein with an additional Wm interface for connection with the AAA server to obtain the QoS subscription information of the Femto AP from the AAA server;

furthermore, the Femto gateway stores locally a list of AP dynamic information in which information on QoSs occupied by sessions currently served by the Femto AP is recorded.

One-to-one correspondence of the list of AP dynamic information to the Femto AP is achieved by an AP identity and the list of AP dynamic information corresponding to the Femto AP records session information on the currently served sessions, where the session information includes UE identities corresponding to the sessions and the information on the QoSs occupied by the sessions and the session information of each of the currently served sessions is recorded in an information row in the list of AP dynamic information. As depicted in Table 1, the AP identity is a unique identity of the Femto AP to identify the Femto AP serving the sessions, e.g., an identifier (ID) or another unique identifier of the Femto AP, the UE identity identifies a UE corresponding to the session currently served by the Femto AP, e.g., a Mobile Subscriber International ISDN Number (MSISDN), or an International Mobile Subscriber Identifier (IMSI), and the information on the QoS identifies the information on the QoS occupied by the session currently served by the Femto AP and is embodied as a QoS parameter of a Radio Access Bearer (RAB) used for the UE in the current session, e.g., a Traffic Class (TC), a Maximum Bit Rate (MBR), and a Guaranteed Bit Rate (GBR). The Femto AP may report the AP identity to the Femto gateway when the UE initiates the session, and the Femto gateway may maintain locally lists of AP dynamic information in one-to-one correspondence to AP identities; and the Femto gateway carries on QoS negotiation at the radio access side for the initiated session, determines information on a QoS occupied by the initiated session and updates the locally stored list of AP dynamic information.

TABLE 1

| Name | Description |
|---|---|
| AP identity | Femto AP serving session (ID or another unique |
| | identifier of Femto AP) |
| UE identity | UE corresponding to session (MSISDN, IMIS, etc.) |
| Information on | QoS parameter of RAB used for UE in current |
| occupied QoS | session (TC, MBR, GBR, etc.) |

A QoS negotiation mechanism at the radio access side for the initiated session in which a Femto gateway acts as a center has been proposed in the first embodiment so that the Femto gateway receives information transmitted as a QoS parameter of an RAB from a CN device on a QoS as requested for allocation to an initiated session when a UE initiates the session, then searches a Femto HLR/HSS or an AAA server for QoS subscription information of a Femto AP accessed by the UE and searches information on QoSs occupied by sessions currently served by the Femto AP, and determines information on a QoS occupied by the initiated session from the three pieces of information and transmits the information on the QoS occupied by the initiated session in the form of the QoS parameter of the RAB to the Femto AP to instruct the Femto AP to set up a radio bearer, and finally feeds a result of QoS negotiation at the radio access side back to the CN device, and also maps the information on the QoS occupied by the initiated session into a QoS parameter of an IP bearer between the Femto gateway and the Femto AP to perform resource allocation and threshold control functions, thereby achieving a guaranteed QoS mechanism of a last-mile access to the Femto AP. Then the Femto AP maps the QoS parameter of the RAB into a QoS parameter of a Radio Bearer (RB) and further into a QoS parameter of UTRAN FDD/TDD to perform physical bearer resource allocation and threshold control functions at the air interface side. Thus an end-to-end controllable QoS management mechanism in the Femto system is achieved indeed.

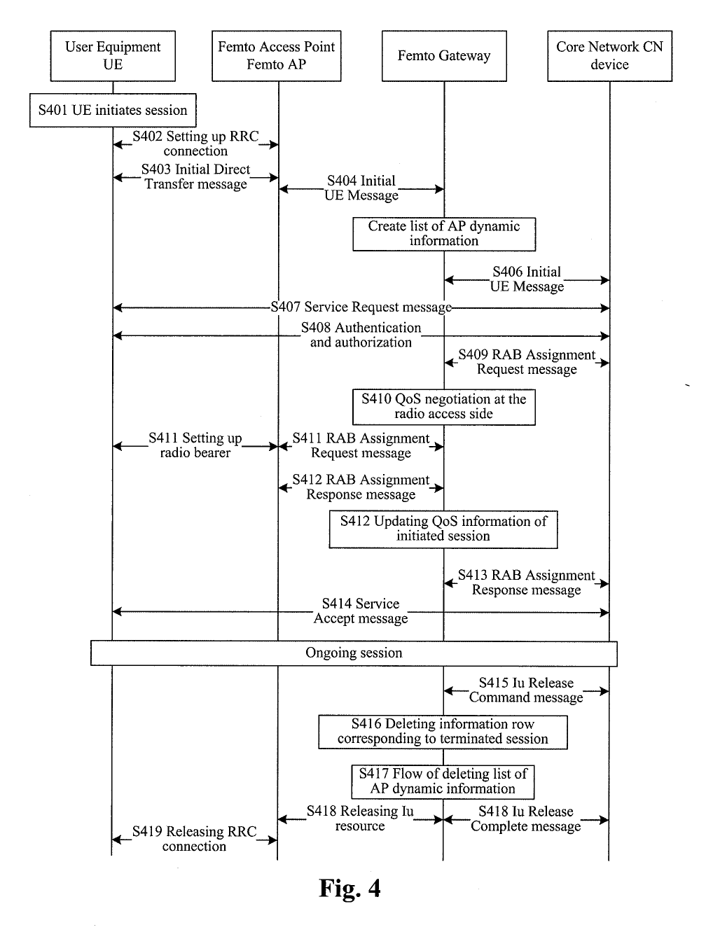

A signaling flow of QoS management on a Femto AP provided in the present embodiment includes the following processes as illustrated in FIG. 4 assuming a UE initiates a session.

S401. The UE initiates the session.

The UE initiates the session by transmitting a session request.

S402. The UE sets up a Radio Resource Control (RRC) connection with the accessed Femto AP.

S403. The UE transmits an Initial Direct Transfer message to the Femto AP;

S404. The Femto AP transmits an Initial UE Message carrying an AP identity of the Femto AP to a Femto gateway in response to the received Initial Direct Transfer message.

In the present embodiment, the format of the Initial UE Message defined in the 3GPP TS 25.413 is modified by modifying a parameter item of Global RNC ID in the message format to a parameter item of Local RNC ID, the AP identity of the Femto AP (e.g., the ID of the Femto AP) is carried in the parameter item to indicate the Femto AP via which the session is initiated, particularly as depicted in Table 2.

TABLE 2

| Name | Description |
|---|---|
| Local RNC ID | Corresponding to parameter item of Global RNC ID |
| | in original message format and with parameter value |
| | being AP identity of Femto AP (ID or another unique |
| | identifier of Femto AP) |

S405. The Femto gateway performs a flow of creating a list of AP dynamic information according to the received AP identity.

The flow of creating the list of AP dynamic information includes: the Femto gateway receives the Initial UE Message transmitted from the Femto AP and extracts the AP identity carried in the parameter item of Local RNC ID, and if a list of AP dynamic information corresponding to the AP identity is absent among locally stored lists of AP dynamic information as a result of a query, the Femto gateway creates for the Femto AP corresponding to the AP identity a new list of AP dynamic information with the extracted AP identity being a unique identity of the list of AP dynamic information.

S406. The Femto gateway transmits to a CN device the Initial UE Message in a format consistent with that defined in the 3GPP TS 25.413 and with a parameter value of the parameter item of Global RNC ID being a Femto Gateway ID.

S407. The Femto AP and the Femto gateway receive the Direct Transfer (DT) message and through-pass in the DT message to the CN a Service Request message transmitted from the UE carrying requested QoS information of the UE, which is embodied as a QoS parameter of a service as requested by the UE.

S408. The UE is authenticated and authorized by the CN device.

S409. After authentication and authorization are passed, the CN device carries on QoS negotiation for the initiated session by combining a QoS policy of the UE with the requested QoS information of the UE and QoS subscription information of the UE stored in a Home Location Register (HLR), maps a result of QoS negotiation into a QoS parameter of an RAB, which may be referred to as information on a QoS as requested for allocation to the initiated session, and transmits the QoS parameter of the RAB to the Femto gateway via an RAB Assignment Request message.

S410. The Femto gateway carries on QoS negotiation at the radio access side, determines information on a QoS occupied by the initiated session and updates the list of AP dynamic information according to the information on the QoS occupied by the initiated session, that is, records an identity of the UE initiating the session and the information on the QoS occupied by the initiated session into the list of AP dynamic information corresponding to the AP identity.

The list of AP dynamic information is updated to add an information row of the initiated session into the list of AP dynamic information, to record session information of the initiated session.

S411. The Femto gateway transmits to the Femto AP the RAB Assignment Request message carrying the information on the QoS occupied by the initiated session in the form of the QoS parameter of the RAB to instruct the Femto AP to set up a radio bearer to the UE according to the information on the QoS occupied by the initiated session.

S412. If the Femto gateway identifies that the information on the QoS occupied by the initiated session (embodied as the QoS parameter of the RAB) has been modified upon reception of an RAB Assignment Response message from the Femto AP, the Femto gateway updates the information on the QoS occupied by the initiated session in the list of AP dynamic information according to the returned modified information on the QoS.

The Femto AP modifies the information on the QoS occupied by the initiated session because the information on the QoS occupied by the initiated session cannot be accommodated when the Femto AP sets up the radio bearer, and after modifying the information on the QoS occupied by the initiated session, the Femto AP sets up the radio bearer to the UE according to the modified information on the QoS and returns the RAB Assignment Response message carrying the modified information on the QoS.

S413. The Femto Gateway transmits to the CN device the RAB Assignment Response message carrying the information on the QoS occupied by the initiated session in the form of a QoS parameter of an RAB as a result of QoS negotiation at the radio access side.

S414. The Femto gateway and the Femto AP through-pass a non-access layer Service Accept message from the CN device to the UE in a DT message.

Then the UE may conduct the session normally, and the information on the QoS occupied by the session may vary with a real time change of the radio bearer but still fall into a range of the original result of QoS negotiation during the normal session of the UE, therefore it is not necessary for the Femto gateway to update the locally stored list of AP dynamic information in real time during the normal session of the UE.

S415. The UE terminates the session, and the UE or a session service platform transmits an Iu Release Command message to the Femto gateway through the CN device.

S416. The Femto gateway deletes the information row corresponding to the terminated session from the locally stored list of AP dynamic information in response to the Iu Release Command message.

S417. The Femto gateway performs a flow of deleting the list of AP dynamic information.

The Femto gateway deletes the list of AP dynamic information upon determining there is no information row in the list of AP dynamic information corresponding to the AP identity, that is, there is no recorded session currently served by the AP.

S418. The Femto gateway transmits an Iu Release Complete message to the CN device to release an Iu resource with the Femto AP.

S419. The RRC connection between the UE and the accessed Femto AP is released.

Thus, the current session of the UE is terminated from the terminal side to the network side.

It shall be noted that the processes S417, S418 and S419 have been numbered merely to simply the description and actually S417 may not be in a strict sequential relationship with S418 and S419.

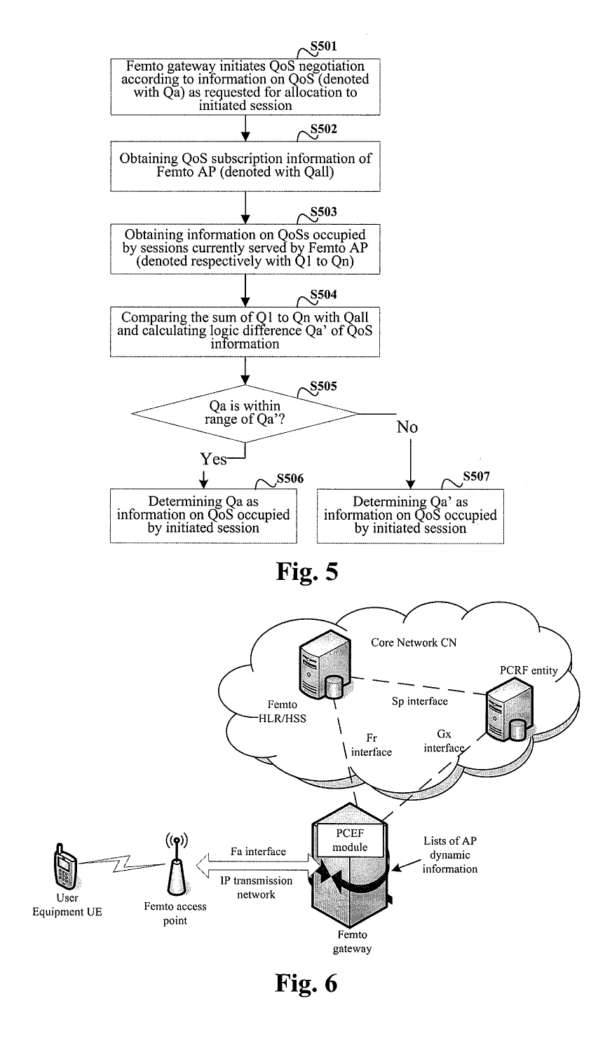

The process flow in which the Femto gateway carries on QoS negotiation at the radio access side and determines the information on the QoS occupied by the initiated session includes the following processes, as illustrated in FIG. 5.

S501. The Femto gateway receives the RAB Assignment Request message carrying the information on the QoS as requested for allocation to the initiated session from the CN device, the information on the QoS as requested for allocation to the initiated session is embodied as the QoS parameter of the RAB denoted with Qa, then initiates a QoS negotiation flow.

S502. The Femto gateway transmits an obtainment request carrying the AP identity to the Femto HLR/HSS or the AAA server and receives the QoS subscription information, denoted with Qall, of the Femto AP returned from the Femto HLR/HSS or the AAA server.

S503. The Femto gateway searches locally stored lists of AP dynamic information for the list of AP dynamic information corresponding to the AP identity and obtains the information on QoSs occupied by sessions currently served by the Femto AP, denoted respectively with Q1 to Qn (n is a natural number).

It shall be noted that the processes S502 and S503 have been numbered merely to simply the description and actually they may not be in a strict sequential relationship.

S504. The Femto gateway compares the information on the QoSs occupied by the sessions currently served by the Femto AP, i.e., the sum of Q1 to Qn, with Qall and calculates a logic difference Qa′ of the QoS information.

S505. The Femto gateway judges whether Qa is within a range of Qa′, and if Qa is within the range of Qa′, the process flow goes to S506; otherwise, the process flow goes to S507.

S506. The Femto gateway determines the information on the QoS as requested for allocation to the initiated session Qa as the information on the QoS occupied by the initiated session and authorizes to admit the session request of the initiated session.

S507. The Femto gateway determines the information on the QoS occupied by the initiated session in a Radio Resource Management (RRM) mechanism and performs admission control on the initiated session.

In the RRM mechanism, it is typical to determine the logic difference Qa′ of the QoS information as the information on the QoS occupied by the initiated session.

The information on the QoS occupied by the initiated session is embodied in the form of the QoS parameter of the RAB and is transmitted to the CN device and the Femto AP and also is mapped into the QoS parameter of the IP bearer to the Femto AP, to perform the resource allocation and threshold control functions and achieve the guaranteed QoS mechanism of the last-mile access to the Femto AP.

### A Second Embodiment

In the present embodiment, a specific application scenario involves a 3GPP PCC architecture Femto system with an Iu protocol based Fa interface. Particularly, the gateway device is a Femto gateway, the AP is a Femto AP hosted by the Femto gateway, and the related information of the Femto AP is authorization information of the Femto AP. In order to implement the present solution, improvements to an existing 3GPP PCC architecture Femto system with an Iu protocol based Fa interface are introduced with reference to FIG. 6, which include:

an additional Policy and Charging Execution Function (PCEF) module is arranged in the Femto gateway and an additional Gx interface is arranged to be connected with a Policy and Charging Rule Function (PCRF) entity in a CN to receive QoS authorization information from the Femto AP;

as in the first embodiment, an additional subscription information storage entity is arranged, and referring to FIG. 6 illustrating an updated Femto HLR/HSS as an example, an additional Sp interface is arranged between the PCRF entity and the Femto HLR/HSS so that the PCRF entity may search the Femto HLR/HSS for QoS subscription information of the Femto AP and determine the QoS authorization information of the Femto AP by combining the QoS subscription information of the Femto AP with QoS policy information of the Femto AP locally stored in the PCRF entity;

if the subscription information storage entity is implemented by updating the AAA server, an additional Sp interface is arranged between the PCRF entity and the AAA server, so that the PCRF entity may search the AAA server for QoS subscription information of the Femto AP and determine the QoS authorization information of the Femto AP by combining the QoS subscription information of the Femto AP with QoS policy information of the Femto AP locally stored in the PCRF entity;

as in the first embodiment, the Femto gateway stores locally a list of AP dynamic information in which information on QoSs occupied by sessions currently served by the Femto AP is recorded.

In the present embodiment, information on a QoS occupied by an initiated session is determined from information on a QoS as requested from a CN device for allocation to the initiated session, information on QoSs occupied by sessions currently served by the Femto AP and the QoS authorization information of the Femto AP in a specific process flow substantially consistent with that presented in the first embodiment except for S502 (where the Femto gateway transmits an obtainment request carrying the AP identity to the Femto HLR/HSS or the AAA server and receives the QoS subscription information, denoted with Qall, of the Femto AP returned from the Femto HLR/HSS or the AAA server) being replaced with:

S502′. the Femto gateway transmits an obtainment request carrying the AP identity to the PCRF entity in the CN and receives the QoS authorization information of the Femto AP, also denoted with Qall, returned from the PCRF entity, through the additional PCEF module.

In the 3GPP PCC architecture Femto system, the QoS policy information of the Femto AP is taken as further input information to the Femto gateway for QoS negotiation at the radio access side to enhance QoS policy control and QoS management on the Femto AP and further improve the end-to-end QoS management mechanism of the Femto system in the PCC architecture.

The signaling flow of QoS management on a Femto AP according to the first embodiment is universally applicable to a Femto system implemented with any air interface technology. A signaling flow of QoS management on a Femto AP in the 3GPP PCC architecture Femto system with an Iu protocol based Fa interface is substantially consistent with that in the first embodiment, and a repeated description thereof is omitted here.

In the signaling flow of QoS management on a Femto AP according to the embodiments of the invention, the QoS negotiation mechanism in which a CN acts as a center is extended to the radio access side and a Femto gateway acts as a center of QoS negotiation and QoS policy control at the radio access side to perform real time associating and binding of an initiated session with a Femto AP via which the session is initiated, thereby accommodating effectively a requirement in a Femto system on differentiated QoS management on the Femto APs.

The signaling flow of QoS management on a Femto AP according to the embodiments of the invention is applicable to a Femto accessing to a 3GPP standard core network but also to a Femto accessing to another core network of a mobile communication system with a guaranteed QoS mechanism to perform end-to-end QoS management, and is applicable to a n architecture with a Policy Control Function (PCF) and Policy Control and Charging (PCC) as defined in the 3GPP R4 but also to that with a PCF and PCC as defined in the 3GPP R5 and later releases. Moreover, the method for QoS management on a Femto AP according to the embodiment of the invention may be extended to a communication system requiring differentiated management on APs other than a Femto system, e.g., a Wireless Local Area Network (WLAN) system, a Pico system.

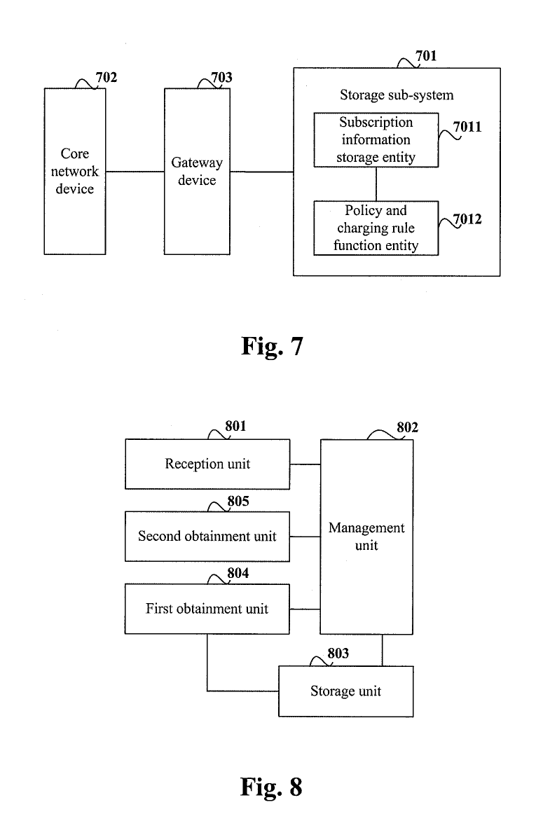

Based upon the same inventive concept, an embodiment of the invention provides a QoS management system as illustrated in FIG. 7 including a storage sub-system 701, a CN device 702 and a gateway device 703.

The storage sub-system 701 is configured to store QoS related information of APs.

The CN device 702 is configured, when a UE initiates a session, to carry on QoS negotiation for the initiated session, and request information on a QoS for allocation to the initiated session according to a result of QoS negotiation.

The CN device may be an MSC, an MSC server or an SGSN, a Serving gateway in the phase of System Architecture Evolvement (SAE), etc.

The gateway device 703 is configured to receive the information on the QoS as requested from the CN device 702 for allocation to the initiated session, determine and record information on a QoS occupied by the initiated session according to the information on the QoS as requested for allocation to the initiated session, information on QoSs occupied by sessions currently served by an AP accessed by the UE and the QoS related information of the AP obtained from the storage sub-system 701, and instruct the AP to set up a radio bearer to the UE according to the information on the QoS occupied by the initiated session.

The QoS related information of the AP includes QoS subscription information of the AP, and then the storage sub-system 701 includes a subscription information storage entity 7011.

The subscription information storage entity 7011 is configured to store the QoS subscription information of the APs.

The subscription information storage entity may be a Femto HLR/HSS or an AAA server in a Femto system.

Alternatively, the QoS related information of the AP includes QoS authorization information of the AP, and then the storage sub-system 702 further includes a PCRF entity 7012.

The PCRF entity 7012 is configured to store the QoS authorization information of the APs, where the QoS authorization information of the AP is determined from the QoS subscription information of the AP obtained from the subscription information storage entity 7011 and locally stored QoS policy information of the AP.

In the QoS management system, the gateway device 703 is further configured to search a list of AP dynamic information corresponding to an AP identity reported from the AP when the UE initiates the session to obtain the information on the QoSs occupied by the sessions currently served by the AP, and to record a UE identity corresponding to the initiated session and the information on the QoS occupied by the initiated session into the list of AP dynamic information corresponding to the AP identity, where the list of AP dynamic information includes the AP identity, UE identities corresponding to the sessions currently served by the AP and the information on the QoSs occupied by the sessions currently served by the AP.

If the AP fails to accommodate the information on the QoS occupied by the initiated session when setting up the radio bearer, the AP modifies the information on the QoS occupied by the initiated session, sets up the radio bearer to the UE according to the modified QoS information and returns a response message carrying the modified QoS information.

The gateway device 703 is further configured to receive the response message returned from the AP after the radio bearer is set up, and to update the recorded information on the QoS occupied by the initiated session according to the returned modified QoS information if the information on the QoS occupied by the initiated session carried in the response message has been modified.

An embodiment of the invention provides a QoS management device, which is preferably arranged in the gateway device 703 but of course may alternatively be arranged in an AP or another network entity capable of radio access control, as illustrated in FIG. 8, the QoS management device includes a reception unit 801 and a management unit 802.

The reception unit 801 is configured to receive information on a QoS as requested, according to a result of QoS negotiation, from a CN device when a UE initiates a session, for allocation to the initiated session.

The management unit 802 is configured to determine and record information on a QoS occupied by the initiated session according to the information on the QoS as requested from the CN device for allocation to the initiated session, information on QoSs occupied by sessions currently served by an AP and QoS related information of the AP.

The QoS management device further includes a storage unit 803, a first obtainment unit 804 and a second obtainment unit 805.

The storage unit 803 is configured to store a list of AP dynamic information including an AP identity, UE identities corresponding to the sessions currently served by the AP and the information on the QoSs occupied by the sessions currently served by the AP.

The first obtainment unit 804 is configured to search the list of AP dynamic information corresponding to the AP identity reported from the AP when the UE initiates the session to obtain the information on the QoSs occupied by the sessions currently served by the AP.

The second obtainment unit 805 is configured to obtain the QoS related information of the AP.

The management unit 802 is further configured to record a UE identity corresponding to the initiated session and the information on the QoS occupied by the initiated session into the list of AP dynamic information corresponding to the AP identity.

The management unit 802 is further configured, when the UE terminates the session, to delete the UE identity corresponding to the terminated session and the information on the QoS occupied by the terminated session from the list of AP dynamic information corresponding to the AP identity, and to delete the list of AP dynamic information when there is no session currently served by the AP recorded in the list of AP dynamic information.

The QoS related information of the AP includes QoS subscription information of the AP, and then the second obtainment unit 805 includes a subscription information obtainment module.

The subscription information obtainment module is configured to obtain the QoS subscription information of the AP from a PCRF entity.

Alternatively, the QoS related information of the AP includes QoS authorization information of the AP, and then the second obtainment unit 805 includes a PCEF module.

The PCEF module is configured to obtain the QoS authorization information of the AP from the PCRF entity.

The management unit 802 may include a calculation module, a judgment module and a determination module.

The calculation module is configured to calculate a logic difference of QoS information according to the information on the QoSs occupied by the sessions currently served by the AP and the QoS related information of the AP.

The judgment module is configured to judge whether the information on the QoS as requested for allocation to the initiated session is within a range of the logic difference of QoS information, and output a judgment result.

The determination module is configured to receive the judgment result, and to determine the information on the QoS as requested for allocation to the initiated session as the information on the QoS occupied by the initiated session if the judgment result is positive or determine the logic difference of QoS information calculated by the calculation module as the information on the QoS occupied by the initiated session if the judgment result is negative.

It will be appreciated that one skilled in the art may make various modifications and alterations to the present invention without departing from the scope of the present invention. Accordingly, if these modifications and alterations to the present invention fall within the scope of the claims of the present invention and their equivalents, the present invention intends to include all these modifications and alterations.

1. A quality of service management method, comprising:
receiving information on a quality of service as requested, according to a result of quality of service negotiation, from a core network device when a user equipment initiates a session for allocation to the initiated session;
determining information on a quality of service occupied by the initiated session according to the information on the quality of service as requested for allocation to the initiated session, information on quality of services occupied by sessions currently served by an access point accessed by the user equipment and quality of service related information of the access point; and
setting up, by the access point, a radio bearer to the user equipment according to the information on the quality of service occupied by the initiated session.

2. The method of claim 19, wherein a gateway device hosting the access point performs:
receiving the information on the quality of service as requested, according to the result of quality of service negotiation, from the core network device when the user equipment initiates the session for allocation to the initiated session; and
determining and recording the information on the quality of service occupied by the initiated session according to the information on the quality of service as requested for allocation to the initiated session, the information on the quality of services occupied by the sessions currently served by the access point accessed by the user equipment and the quality of service related information of the access point.

3. The method of claim 2, further comprising: if the access point fails to accommodate the information on the quality of service occupied by the initiated session when setting up the radio bearer,
modifying, by the access point, the information on the quality of service occupied by the initiated session, setting up a radio bearer to the user equipment according to the modified information on the quality of service, and returning a response message carrying the modified information on the quality of service; and
updating, by the gateway device, the recorded information on the quality of service occupied by the initiated session according to the returned modified information on the quality of service.

4. The method of claim 2, wherein, obtaining the information on the quality of services occupied by the sessions currently served by the access point comprises:
receiving an access point identity reported from the access point when the user equipment initiates the session; and
searching for a list of access point dynamic information corresponding to the access point identity to obtain the information on the quality of services occupied by the sessions currently served by the access point, wherein the list of access point dynamic information comprises the access point identity, user equipment identities corresponding to the sessions currently served by the access point and the information on the quality of services occupied by the sessions currently served by the access point.

5. The method of claim 4, further comprising: if no list of access point dynamic information corresponding to the access point identity is found,
creating, by the gateway device, a list of access point dynamic information corresponding to the access point identity.

6. The method of claim 5, further comprising: if the user equipment terminates the session,
deleting, by the gateway device, a user equipment identity corresponding to the terminated session and the information on the quality of service occupied by the terminated session from the list of access point dynamic information corresponding to the access point identity; and
deleting the list of access point dynamic information when there is no session currently served by the access point recorded in the list of access point dynamic information.

7. The method of claim 1, wherein the quality of service related information of the access point comprises: quality of service subscription information or quality of service authorization information of the access point; and
the quality of service subscription information of the access point is obtained from a subscription information storage entity; and
the quality of service authorization information of the access point is obtained from a policy and charging rule function entity.

8. The method of claim 1, wherein determining the information on the quality of service occupied by the initiated session comprises:
determining a logic difference of quality of service information according to the information on the quality of services occupied by the sessions currently served by the access point and the quality of service related information of the access point; and
judging whether the information on the quality of service as requested for allocation to the initiated session is within a range of the logic difference of quality of service information, and if so, determining the information on the quality of service as requested for allocation to the initiated session as the information on the quality of service occupied by the initiated session; otherwise, determining the logic difference of quality of service information as the information on the quality of service occupied by the initiated session.

9. The method of claim 1, wherein the access point is a Femto access point.

10. A quality of service management device, comprising:
a reception unit configured to receive information on a quality of service as requested, according to a result of quality of service negotiation, from a core network device when a user equipment initiates a session for allocation to the initiated session; and
a management unit configured to determine and record information on a quality of service occupied by the initiated session according to the information on the quality of service as requested for allocation to the initiated session, information on quality of services occupied by sessions currently served by an access point accessed by the user equipment and quality of service related information of the access point.

11. The device of claim 10, further comprising:
a storage unit configured to store a list of access point dynamic information comprising an access point identity, user equipment identities corresponding to the sessions currently served by the access point and the information on the quality of services occupied by the sessions currently served by the access point;
a first obtainment unit configured to search for the list of access point dynamic information corresponding to the access point identity reported from the access point when the user equipment initiates the session to obtain the information on the quality of services occupied by the sessions currently served by the access point; and
a second obtainment unit configured to obtain the quality of service related information of the access point; and
the management unit is further configured to record a user equipment identity corresponding to the initiated session and the information on the quality of service occupied by the initiated session into the list of access point dynamic information corresponding to the access point identity.

12. The device of claim 11, wherein the quality of service related information of the access point comprises quality of service subscription information or quality of service authorization information of the access point, and the second obtainment unit comprises:
a subscription information obtainment module configured to obtain the quality of service subscription information of the access point from a subscription information storage entity; or
a policy and charging execution function module configured to obtain the quality of service authorization information of the access point from a policy and charging rule function entity.

13. The device of claim 11, wherein the management unit comprises:
a calculation module configured to calculate a logic difference of quality of service information according to the information on the quality of services occupied by the sessions currently served by the access point and the quality of service related information of the access point;
a judgment module configured to judge whether the information on the quality of service as requested for allocation to the initiated session is within a range of the logic difference of quality of service information, and output a judgment result; and
a determination module configured to receive the judgment result, and to determine the information on the quality of service as requested for allocation to the initiated session as the information on the quality of service occupied by the initiated session if the judgment result is positive or determine the logic difference of quality of service information calculated by the calculation module as the information on the quality of service occupied by the initiated session if the judgment result is negative.

14. A quality of service management system, comprising:
a storage sub-system configured to store quality of service related information of access points;
a core network device configured, when a user equipment initiates a session, to carry on quality of service negotiation for the initiated session, and request information on a quality of service for allocation to the initiated session according to a result of quality of service negotiation; and
a gateway device configured to receive the information on the quality of service as requested from the core network device for allocation to the initiated session, determine information on a quality of service occupied by the initiated session according to the information on the quality of service as requested for allocation to the initiated session, information on quality of services occupied by sessions currently served by an access point accessed by the user equipment and the quality of service related information of the access point obtained from the storage sub-system, and instruct the access point to set up a radio bearer to the user equipment according to the information on the quality of service occupied by the initiated session.

15. The system of claim 14, wherein the gateway device is further configured to search a list of access point dynamic information corresponding to an access point identity reported from the access point when the user equipment initiates the session to obtain the information on the quality of services occupied by the sessions currently served by the access point, and to record a user equipment identity corresponding to the initiated session and the information on the quality of service occupied by the initiated session into the list of access point dynamic information corresponding to the access point identity, wherein the list of access point dynamic information comprises the access point identity, user equipment identities corresponding to the sessions currently served by the access point and the information on the quality of services occupied by the sessions currently served by the access point.

16. The system of claim 15, wherein the gateway device is further configured to receive a response message returned from the access point after the radio bearer is set up, and to update the recorded information on the quality of service occupied by the initiated session according to the returned modified quality of service information if the information on the quality of service occupied by the initiated session carried in the response message has been modified.

17. The system of claim 14, wherein the quality of service related information of the access point comprises quality of service subscription information or quality of service authorization information of the access point, and the storage sub-system comprises:
a subscription information storage entity configured to store the quality of service subscription information of the access points; or
a policy and charging rule function entity configured to store the quality of service authorization information of the access points, wherein the quality of service authorization information of the access point is determined from the quality of service subscription information of the access point obtained from the subscription information storage entity and locally stored quality of service policy information of the access point.

18. The system of claim 14, wherein the gateway device is a Femto gateway device.

19. The method of claim 1, further comprising:
recording the information on the quality of service occupied by the initiated session.
